(19) United States
(12) Patent Application Publication
(10) Pub. No.: US 2017/0161289 A1
(43) Pub. Date: Jun. 8, 2017

(54) SYSTEM TO IMPROVE DATA EXCHANGE USING ADVANCED DATA ANALYTICS

(71) Applicant: Hartford Fire Insurance Company, Hartford, CT (US)

(72) Inventors: Brian Michael Ignatowicz, West Hartford, CT (US); Benjamin L. Schimelman, Middletown, CT (US)

(21) Appl. No.: 14/962,166

(22) Filed: Dec. 8, 2015

(51) Int. Cl. G06F 17/30; G06Q 40/08; G06Q 40/06; H04L 29/08

(52) U.S. Cl. CPC G06F 17/3097; H04L 67/10; G06Q 40/08; G06Q 40/06

(57) ABSTRACT

Systems, methods, apparatus, computer program code and means to improve data exchange with a remote client device are provided. In some embodiments, a back end application server may receive from the remote computer a first set of parameters. The server may automatically identify an initial set of values based on the first set of parameters and historic interaction information and render an initial display on the remote computer including information about the initial set of values. The server may then receive a recommendation request including a second set of parameters and automatically exchange information with a cloud-based advanced data analytics platform to determine at least one recommended adjustment. The server may then render a recommendation display on the remote computer including the initial set of values and the at least one recommended adjustment.

### BACKGROUND

Data driven entities increasingly are dependent on a wider variety and amount of data derived or accessed from multiple disparate sources and networks. Significant challenges exist with integrating complex and sophisticated information technology solutions in order to perform large-scale transactional data management while maintaining data quality and access. Advanced intelligence and analytics are needed to help make helpful, cognitive improvement recommendations and to make use of complex data for effective and reliable decision making.

It would be desirable to provide systems and methods to recommend value adjustments that achieve faster, better results and that allow for flexibility and accuracy in an amount of protection that may be achieved.

### SUMMARY OF THE INVENTION

According to some embodiments, systems, methods, apparatus, computer program code and means for recommending value adjustments are provided. Some embodiments provide systems, methods, apparatus, computer program code and means to improve data exchange with a remote client device. For example, a back end application server may receive from a remote computer a first set of parameters. The server may automatically identify an initial set of values based on the first set of parameters and historic interaction information and render an initial display on the remote computer including information about the initial set of values. The server may then receive a recommendation request including a second set of parameters and automatically exchange information with a cloud-based advanced data analytics platform to determine at least one recommended adjustment. The server may then render a recommendation display on the remote computer including the initial set of values and the at least one recommended adjustment.

Some embodiments comprise: means for exchanging electronic messages with a remote computer via the Internet, the remote computer being associated with a potential entity; means for receiving, by a back-end application computer server from the remote computer, a set of parameters; means for automatically identifying, by the back-end application computer server, an initial set of coverage values and associated amounts based on the set of parameters and the historic information, including historic information associated with entities other than the potential entity; means for rendering, by the back-end application computer server, an initial display on the remote computer including the initial set of coverage values and associated amounts; means for receiving, by the back-end application computer server from the remote computer, a recommendation request including a set of supplemental parameters; means for automatically exchanging information with the cloud-based advanced data analytics platform, including information about the set of supplemental parameters, to determine at least one recommended adjustment associated with the initial set of values and associated amounts; and means for rendering a recommendation display on the remote computer including the initial set of values and associated amounts along with the at least one recommended adjustment.

In some embodiments, a communication device associated with a back-end application computer server exchanges information with remote devices. The information may be exchanged, for example, via public and/or proprietary communication networks.

A technical effect of some embodiments of the invention is an improved and computerized generation of recommended value adjustments. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method according to some embodiments of the present invention.

FIG. 3 is block diagram of a system in accordance with embodiments of the present invention.

FIGS. 4 through 12 illustrate exemplary displays that might be provided according to some embodiments.

FIG. 13 is a block diagram of an apparatus in accordance with some embodiments of the present invention.

FIG. 14 is a portion of a tabular database storing potential insurance policy information in accordance with some embodiments.

FIG. 15 illustrates a tablet computer displaying insurance related information according to some embodiments.

FIG. 16 is a partially functional block diagram that illustrates aspects of a computer system with a predictive model provided in accordance with some embodiments of the invention.

### DETAILED DESCRIPTION

The present invention provides significant technical improvements to facilitate dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of adjustment recommendations by providing technical benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized insurance, client, and/or third party systems, networks and subsystems. For example, in the present invention information may be transmitted from remote devices to a back-end application server and then analyzed accurately to improve recommendation response times, and improve data that may be automatically collected by an enterprise.

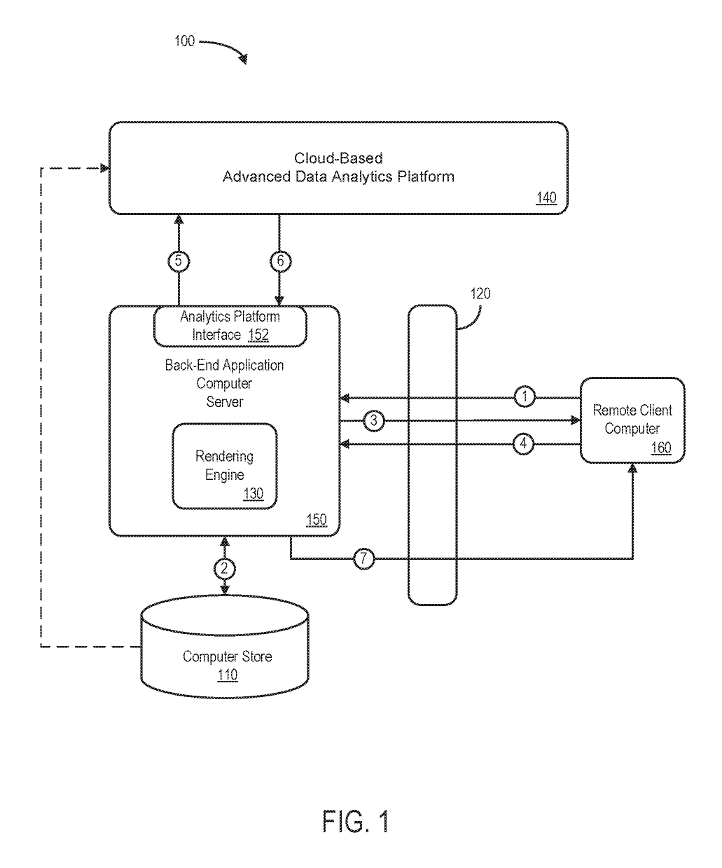

Data driven entities increasingly are dependent on a wider variety and amount of data derived or accessed from multiple disparate sources and networks. Significant challenges exist with integrating complex and sophisticated information technology solutions in order to perform large-scale transactional data management while maintaining data quality and access. Advanced intelligence and analytics are needed to help make helpful, cognitive improvement recommendations and to make use of complex data for effective and reliable decision making. It would be desirable to provide systems and methods to recommend value adjustments that achieve faster, better results and that allow for flexibility and accuracy in an amount of protection that may be achieved. FIG. 1 is block diagram of a system 100 according to some embodiments of the present invention. In particular, the system 100 includes a back-end application computer server 150 that may access information in a computer store 110. The back-end application computer server 150 may also exchange information with a remote client computer 160 (e.g., via a firewall 120) and/or a cloud-based advanced data analytics platform 140 (e.g., via a smart analytics interface 152). According to some embodiments, a rendering engine 130 of the back-end application computer server 150 may facilitate the display of information via one or more remote client computers 160.

The back-end application computer server 150 might be, for example, associated with a Personal Computer (“PC”), laptop computer, smartphone, an enterprise server, a server farm, and/or a database or similar storage devices. According to some embodiments, an “automated” back-end application computer server 150 may facilitate the provision of recommended adjustments. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the computer store 110. The computer store 110 might be associated with, for example, an insurance company, an underwriter, or a claim analyst and might also store data associated with past and current insurance claims. The computer store 110 may be locally stored or reside remote from the back-end application computer server 150. As will be described further below, the computer store 110 may be used by the back-end application computer server 150 to generate and/or calculate parameters to be transmitted to the remote client computer 160. Although a single back-end application computer server 150 is shown in FIG. 1, any number of such devices may be included. Moreover, various devices described herein might be combined according to embodiments of the present invention. For example, in some embodiments, the back-end application computer server 150 and computer store 110 might be co-located and/or may comprise a single apparatus.

According to some embodiments, the system 100 may improve data exchange over a distributed communication network via the automated back-end application computer server. For example, the computer store 110 may contain data for a plurality of prior interactions, including historic interaction information for each interaction. A communication port may facilitate an exchange of electronic messages with the remote client computer 160 via the distributed communication network, the remote client computer 160 being associated with a potential client entity. The back-end application computer server 150 may receive at (1) from the remote client computer 160 a first set of parameters and automatically identify an initial set of values based on the first set of parameters and the historic interaction information in the computer store 110 at (2), including historic interaction information associated with entities other than the potential client entity. The back-end application computer server 150 may render an initial display at (3) on the remote client computer 160 including information about the initial set of values. The back-end application computer server 150 may then receive from the remote client computer 160 at (4) a recommendation request including a second set of parameters, the second set of parameters being different than the first set of parameters.

At (5) and (6), the back-end application computer server 150 may automatically exchange information with the cloud-based advanced data analytics platform 140, including information about the second set of parameters, to determine at least one recommended adjustment associated with the initial set of values. The back-end application computer server 150 may then render a recommendation display at (7) on the remote client computer 160 including the initial set of values and the at least one recommended adjustment.

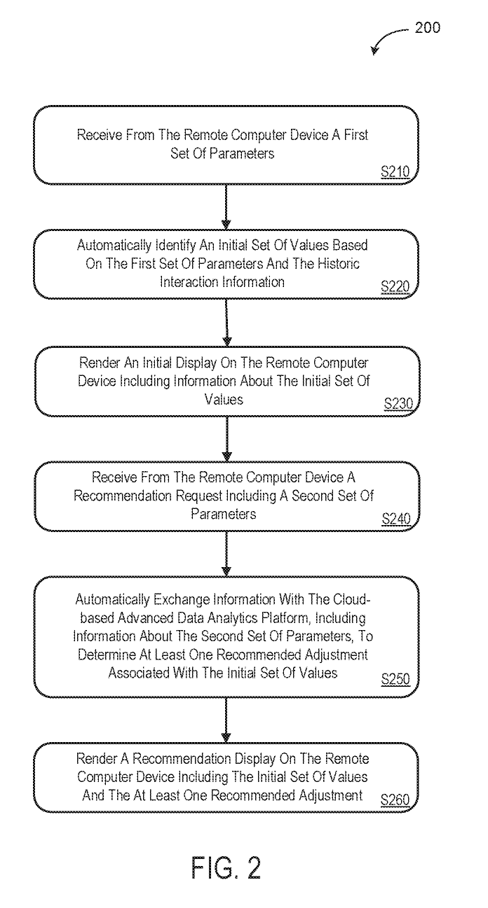

Note that the system 100 of FIG. 1 is provided only as an example, and embodiments may be associated with additional elements or components. According to some embodiments, the elements of the system improve data exchange over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a back-end application computer server, coupled to a computer store, a cloud-based advanced data analytics platform, and a communication port, may receive from the remote client computer a first set of parameters. At S220, the back-end application computer server may automatically identify an initial set of values based on the first set of parameters and the historic interaction information, including historic interaction information associated with entities other than the potential client entity. At S230, the back-end application computer server may render an initial display on the remote client computer including information about the initial set of values.

At S240, the back-end application computer server may receive from the remote client computer a recommendation request including a second set of parameters, the second set of parameters being different than the first set of parameters. At S250, the back-end application computer server may automatically exchange information with the cloud-based advanced data analytics platform, including information about the second set of parameters, to determine at least one recommended adjustment associated with the initial set of values. According to some embodiments, the cloud-based advanced data analytics platform includes at least one of: an instance created for the back-end application computer server, security features, a cognitive computing service, and content services. Note that the second set of parameters may include any other type or types of data, including: third party data, social networking data, etc. According to some embodiments, the system may ingest other outside information (e.g., upon customer approval), including information from other online accounts, insurance policies, etc. The second set of parameters may represent supplemental information that (perhaps when combined with past claims experiences) may automatically generate recommendations for that particular potential insured. For example, the system might notice that there is little highway driving associated with a potential client entity's home and work addresses. As a result, the insurance recommendations may be adjusted as appropriate. Another example might involve information that the cloud-based advanced data analytics platform has uncovered as being relevant. For example, it might be determined that a particular ZIP code is associated with an average yearly income value over a pre-determined threshold value. As a result, a recommended amount of insurance, deductible value, and/or type of insurance might be suggested as being appropriate for someone who lives in that ZIP code. In this way, the system may tailor information for potential clients in a detailed and accurate way.

At S260, the back-end application computer server may render a recommendation display on the remote client computer including the initial set of values and the at least one recommended adjustment. According to some embodiments, at least one of the second set of parameters and the recommended adjustment are exchanged with the remote client computer via a real-time interactive chat application. For example, a “Live Chat” feature may interact with the potential client via natural language text and/or a speech interface.

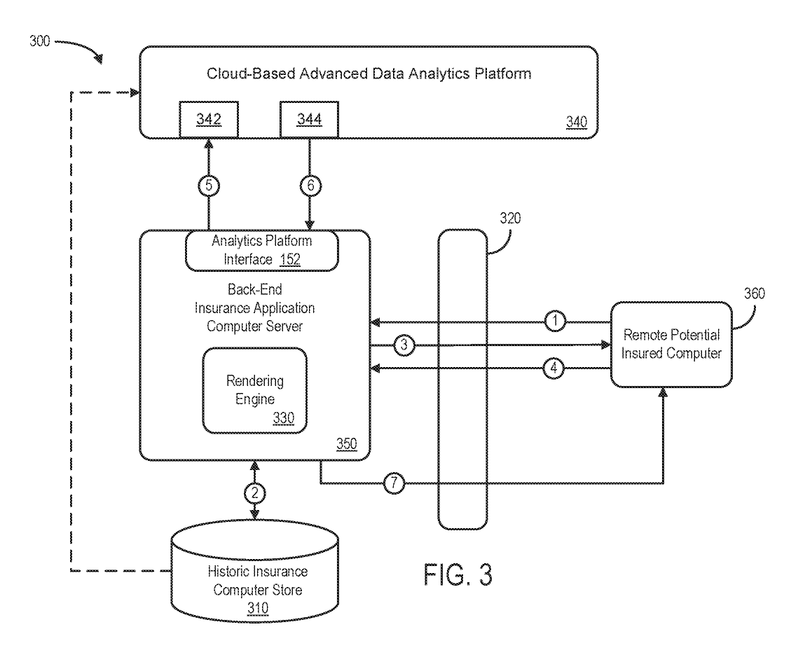

Some of the embodiments described herein may be implemented via an insurance quoting and/or underwriting system. For example, FIG. 3 is block diagram of a system 300 according to some embodiments of the present invention. As in FIG. 1, the system 300 includes a back-end insurance computer server 350 that may access information in a historic insurance computer store 310. The back-end insurance computer server 350 may also exchange information with a remote potential insured computer 360 (e.g., a smartphone or web portal communicating via a firewall 320) and/or a cloud-based advanced data analytics platform 340 (e.g., via a smart analytics interface 352). The cloud-based advanced data analytics platform may include one or more communication ports 342, 344 to provide instance creation, load balancing, security functions, etc.

According to some embodiments, a rendering engine 330 of the back-end insurance computer server 350 may facilitate the display of information via one or more remote potential insured computers 360. The back-end insurance computer server 350 might be, for example, associated with a PC, laptop computer, smartphone, an enterprise server, a server farm, and/or a database or similar storage devices. According to some embodiments, an “automated” back-end insurance computer server 350 may facilitate the provision of recommended adjustments. As used herein, the term “automated” may refer to, for example, actions that can be performed with little (or no) intervention by a human.

As used herein, devices, including those associated with the back-end insurance computer server 350 and any other device described herein may exchange information via any communication network which may be one or more of a LAN, a MAN, a WAN, a proprietary network, a PSTN, a WAP network, a Bluetooth network, a wireless LAN network, and/or an IP network such as the Internet, an intranet, or an extranet. Note that any devices described herein may communicate via one or more such communication networks.

The back-end insurance computer server 350 may store information into and/or retrieve information from the computer store 310. The computer store 310 might be associated with, for example, an insurance company, an underwriter, or a claim analyst and might also store data associated with past and current insurance policies and claims. The computer store 310 may be locally stored or reside remote from the back-end insurance computer server 350. As will be described further below, the computer store 310 may be used by the back-end insurance computer server 350 to generate and/or calculate insurance parameters (e.g., premium values) to be transmitted to the remote potential insured computer 360. Although a single back-end insurance computer server 350 is shown in FIG. 3, any number of such devices may be included. Moreover, various devices described herein might be combined according to embodiments of the present invention. For example, in some embodiments, the back-end insurance computer server 350 and historic insurance computer store 310 might be co-located and/or may comprise a single apparatus.

According to some embodiments, the system 300 may improve data exchange over the Internet via the automated back-end insurance computer server 350. For example, the historic insurance computer store 310 may contain data for a plurality of prior insurance policies, premiums, and associated claims, including historic interaction information for each policy, premium, claim, etc. A communication port may facilitate an exchange of electronic messages with the remote potential insured computer 360 via the Internet, the remote potential insured computer 360 being associated with a potential client entity. The back-end insurance computer server 350 may receive at (1) from the remote potential insured computer 360 a first set of parameters. The first set of parameters might include, for example, vehicle information for at least one vehicle, driver information for at least one driver, address information, discount information for at least one discount, and/or driving incident information (e.g., associated with prior accidents or speeding tickets).

The back-end insurance computer server 350 may then automatically identify an initial set of values based on the first set of parameters and the historic interaction information in the historic insurance computer store 310 at (2), including historic interaction information associated with entities other than the potential client entity. The back-end insurance computer server 350 may render an initial display at (3) on the remote potential insured computer 360 including information about the initial set of values. The initial set of values might include, for example, a bodily injury liability value, a property damage liability value, a medical payment value, an uninsured and underinsured motorist bodily injury value, an uninsured motorist property damage value, a towing and labor roadside assistance value, a rental reimbursement value, a comprehensive coverage value, and/or at least one insurance premium value.

The back-end insurance computer server 350 may then receive from the remote potential insured computer 360 at (4) a recommendation request including a second set of parameters, the second set of parameters being different than the first set of parameters. For example, the potential insured might request that an insurance coverage advisor tool be executed. In this case, the second set of parameters might include financial information, such as a net worth value, an amount of funds currently available value, an existing roadside assistance plan value, a health insurance deductible value, and/or a retirement savings value.

At (5) and (6), the back-end insurance computer server 350 may automatically exchange information with the cloud-based advanced data analytics platform 340, including information about the second set of parameters, to determine at least one recommended adjustment associated with the initial set of values. The back-end insurance computer server 350 may then render a recommendation display at (7) on the remote potential insured computer 360 including the initial set of values and the at least one recommended adjustment. For example, the recommended adjustment might indicate that an insurance limit should be increased from $25,000 to $250,000. Note that embodiments might be associated with, for example, a potential automobile insurance policy and/or a potential homeowner's insurance policy. Embodiments associated with a homeowner's insurance policy may of course utilize different information inputs (and different ways of receiving those inputs) as well as different types of recommendations (and different ways of providing those recommendations).

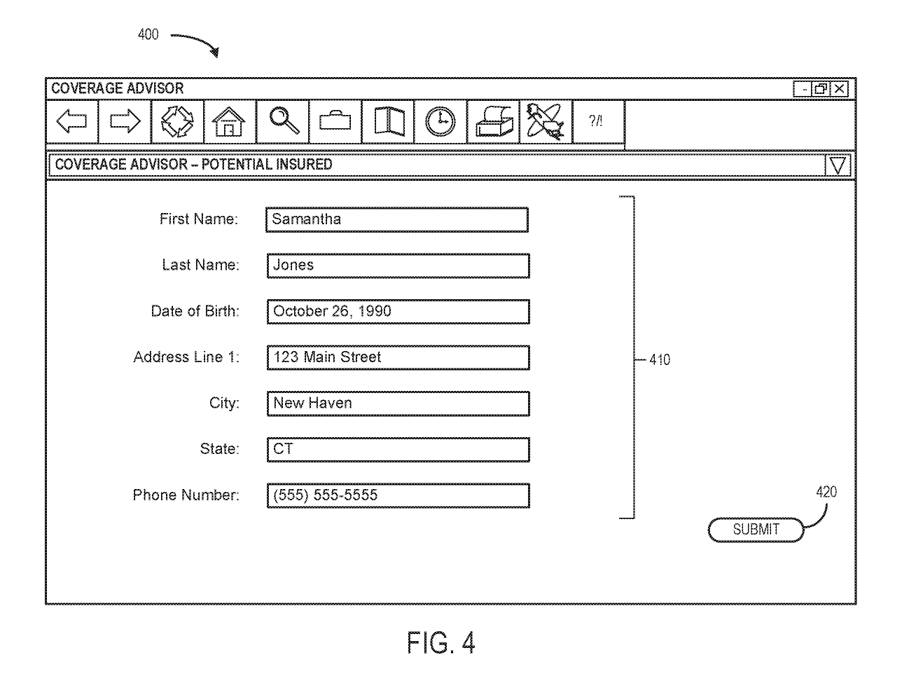

FIGS. 4 through 12 illustrate exemplary displays that might be provided according to some embodiments. For example, FIG. 4 illustrates a potential insured information display 400 that might be provided to a potential insured according to some embodiments. The potential insured information display 400 may be used, for example, to enter, review, and/or revise information 410 about a party seeking insurance. The information 410 might include, for example, a name, address, date of birth, and/or phone number. Other information that could be included in the display 400 might include the party's email address and a submit icon 420 that triggers submission of the information 410 to a back-end insurance application computer server. Note that embodiments are not limited to parties seeking new insurance policies. For example, any of the embodiments described herein may be associated with an existing insurance policy (e.g., the system might proactively recommend changes to an existing policyholder), a request for renewal, etc. In the case of an existing insurance policy, the system may already possess supplemental information about the policyholder.

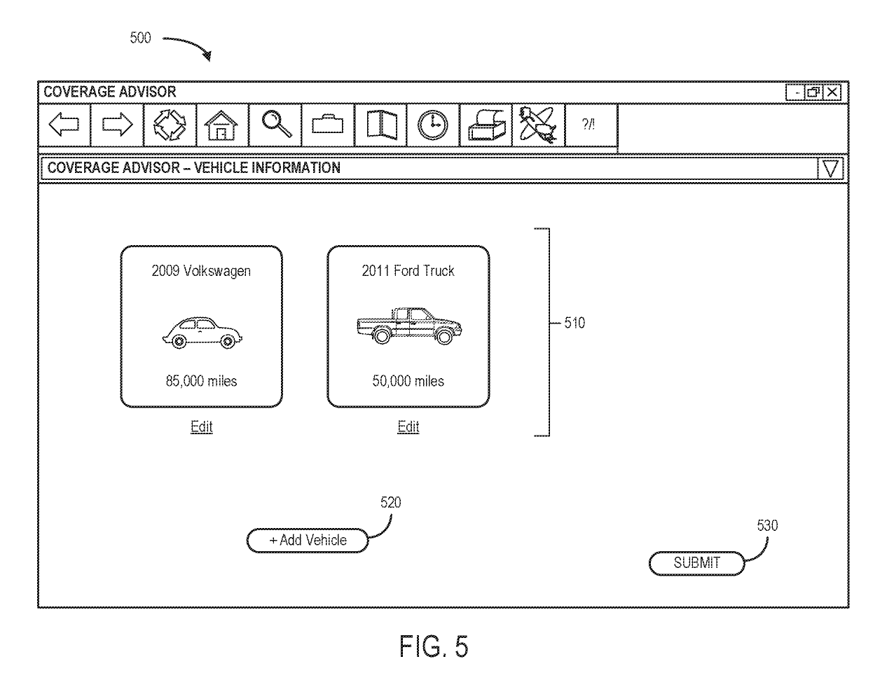

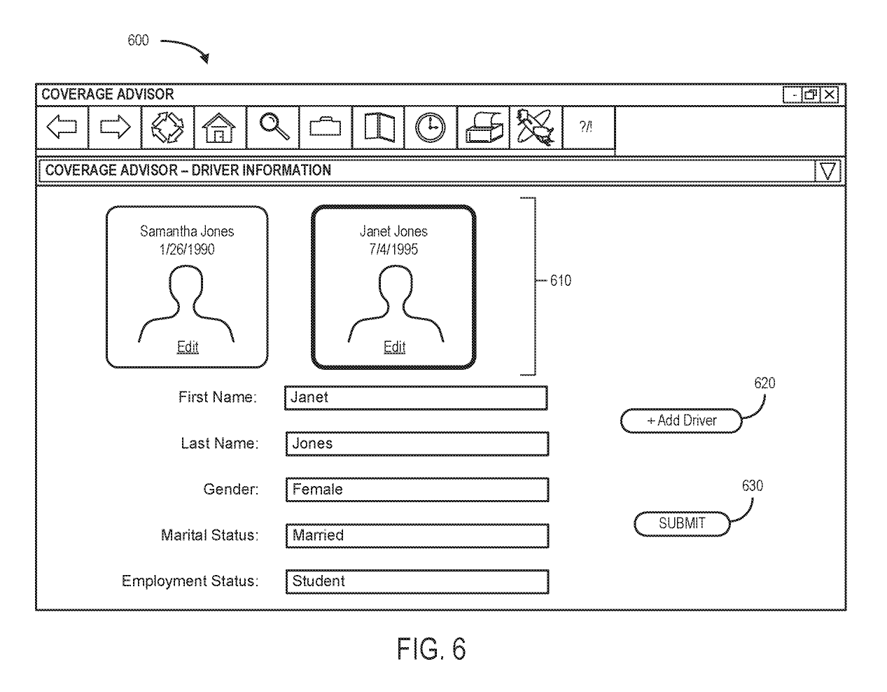

FIG. 5 illustrates a vehicle information display 500 that might be provided to a potential insured according to some embodiments. The display 500 might let a potential insured enter, review, and/or revise information 510 about one or more vehicles to be covered under the potential insurance policy (e.g., an automobile manufacture and model, a number of miles driven, etc.). The display 500 may further let the potential insured add another vehicle 520 and/or activate a submit icon 530 that triggers submission of the information 510 to a back-end insurance application computer server. Similarly, FIG. 6 illustrates a driver information display 600 that might be provided to a potential insured according to some embodiments. The display 600 might let a potential insured enter, review, and/or revise information 610 about one or more drivers to be covered under the potential insurance policy. The information might include, for example, a name, a gender, a marital status, and/or an employment status. Other information that might be provided via the display 600 includes, for example, a relationship, how long the driver has be licensed, an indication if the driver is away at school, an indication of prior accidents, an indication of a student's grades or class rank, etc. The display 600 may further let the potential insured add another driver 620 and/or activate a submit icon 630 that triggers submission of the information to a back-end insurance application computer server.

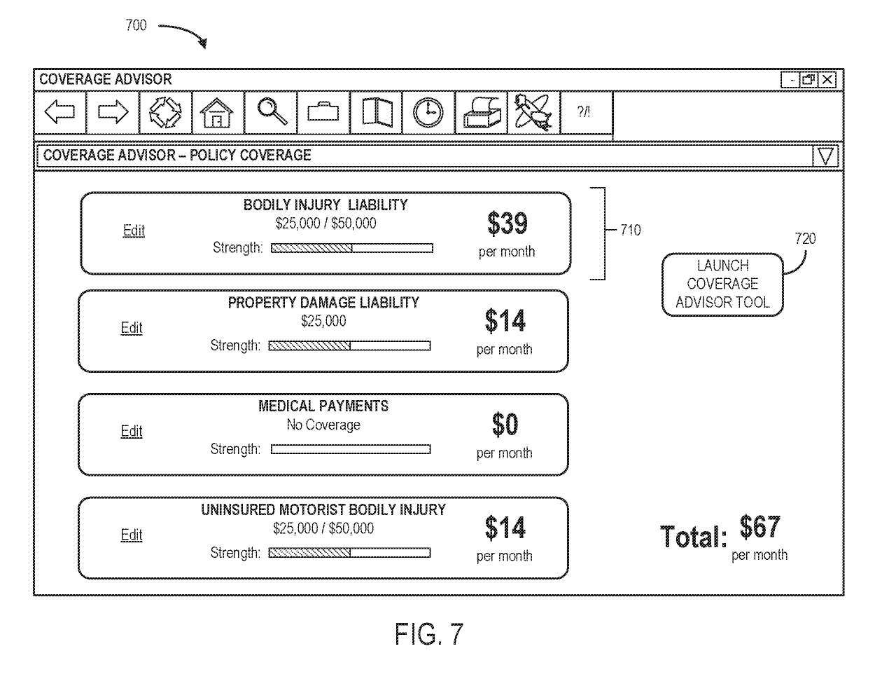

FIG. 7 illustrates a policy coverage display 700 that might be provided to a potential insured according to some embodiments. The coverage display includes, for multiple different types of insurance coverages, a policy coverage indication 710 that includes a policy coverage description, a graphical strength indication, and premium value or cost. The insurance coverages associated with the display 700 might include, for example, bodily injury liability, property damage liability, medical payments, uninsured and/or underinsured motorist bodily injury, uninsured motorist property damage, etc. The coverage display 700 may also include vehicle-specific insurance options, such as towing and labor, comprehensive coverage, rental reimbursement, etc. The coverage display 700 may further include a total monthly premium value (e.g., representing the sum of each premium value for the individual coverage indications 710).

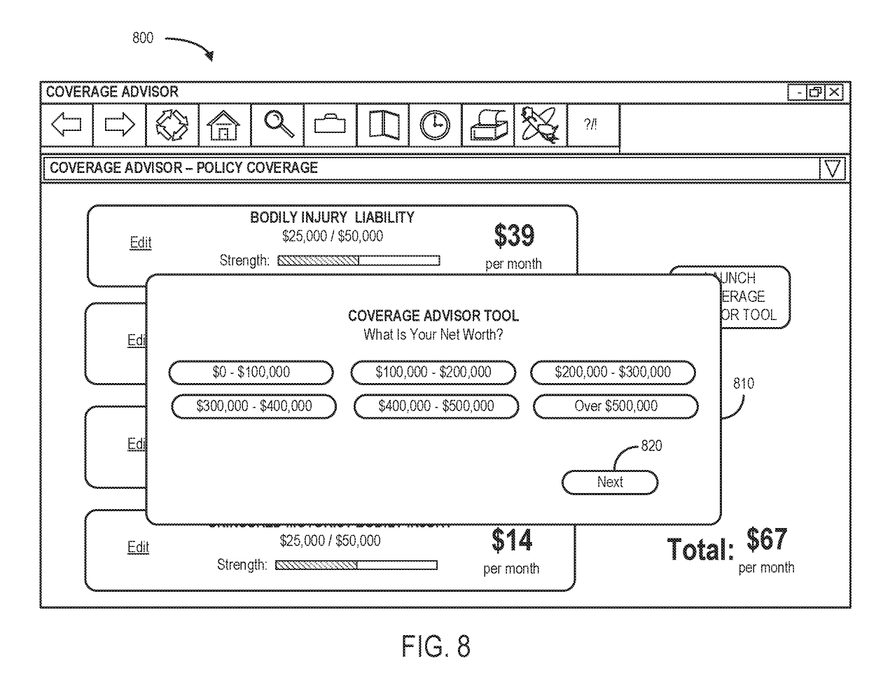

The coverage display 700 may further include a “Launch Coverage Advisor Tool” icon 720. Selection of the icon may result in execution of an insurance coverage advisor tool. FIGS. 8 through 11 illustrate insurance coverage advisor tool displays that might be provided to a potential insured according to some embodiments. For example, FIG. 8 illustrates a display 800 including a tool pop-up window 810 asking the potential insured for financial information. In particular, the tool pop-up window 810 asks the potential insured to classify his or her current net worth value (e.g., from $100,000 to $200,000, from $200,000 to $300,000, etc.). Selection of a “Next” icon 820 may submit the information to a back-end insurance application computer server.

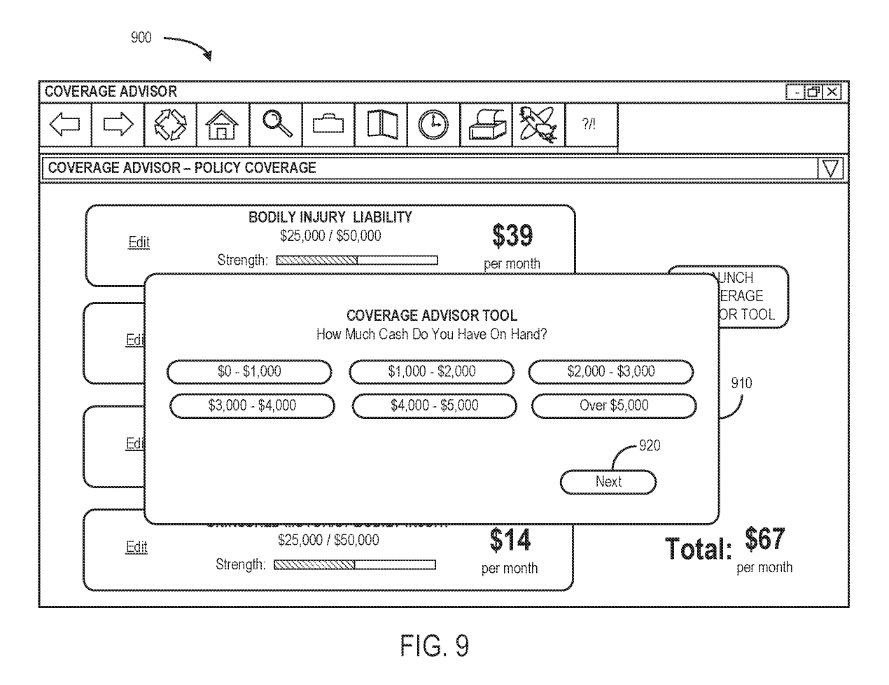

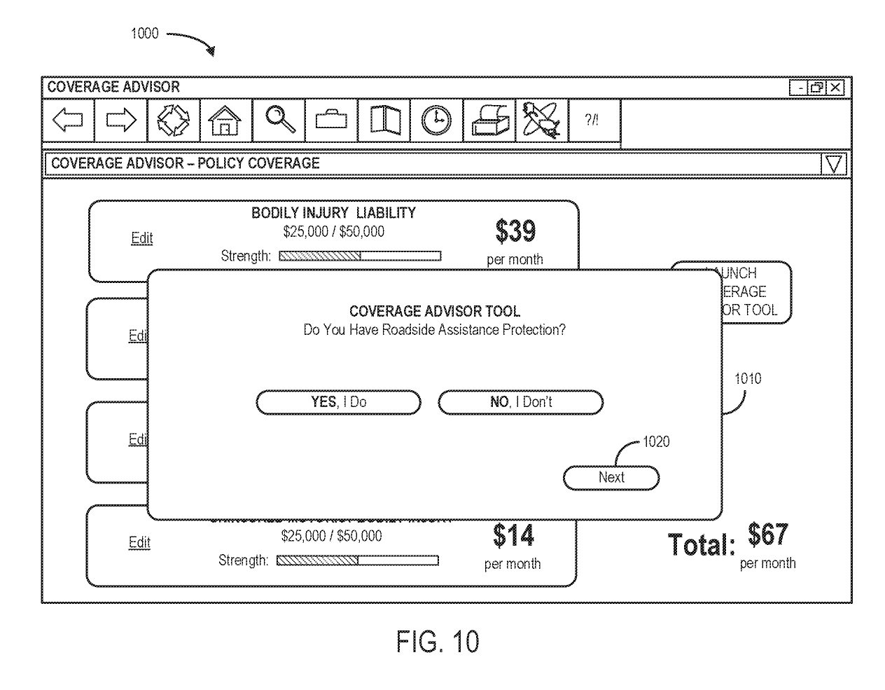

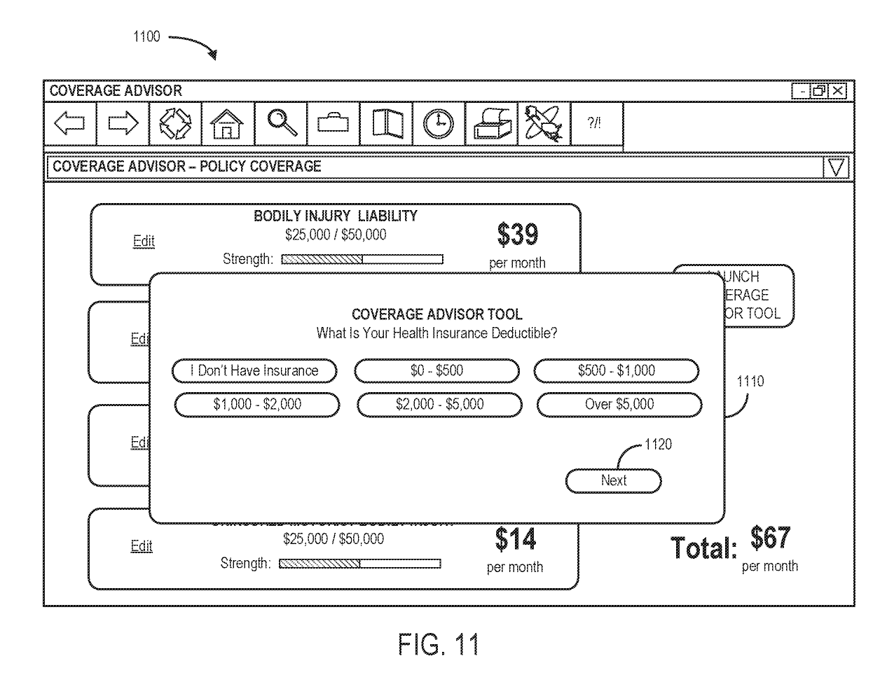

FIG. 9 illustrates a display 900 including a tool pop-up window 910 that might be used to ask a potential insured to classify how much cash she or he current has on hand (e.g., from $1,000 to $2,000, from $2,000 to $3,000, etc.) according to some embodiments. Selection of a “Next” icon 920 may submit the information to a back-end insurance application computer server. FIG. 10 illustrates a display 1000 including a tool pop-up window 101 that might be used to ask a potential insured about specific existing protections, such as roadside assistance protection, according to some embodiments. Selection of a “Next” icon 1020 may submit the information to a back-end insurance application computer server. FIG. 11 illustrates a display 1100 including a tool pop-up window 1110 that might be used to ask a potential insured to classify his or her medical insurance deductible (e.g., from $500 to $1,000, from $1,000 to $2,000 etc.) according to some embodiments.

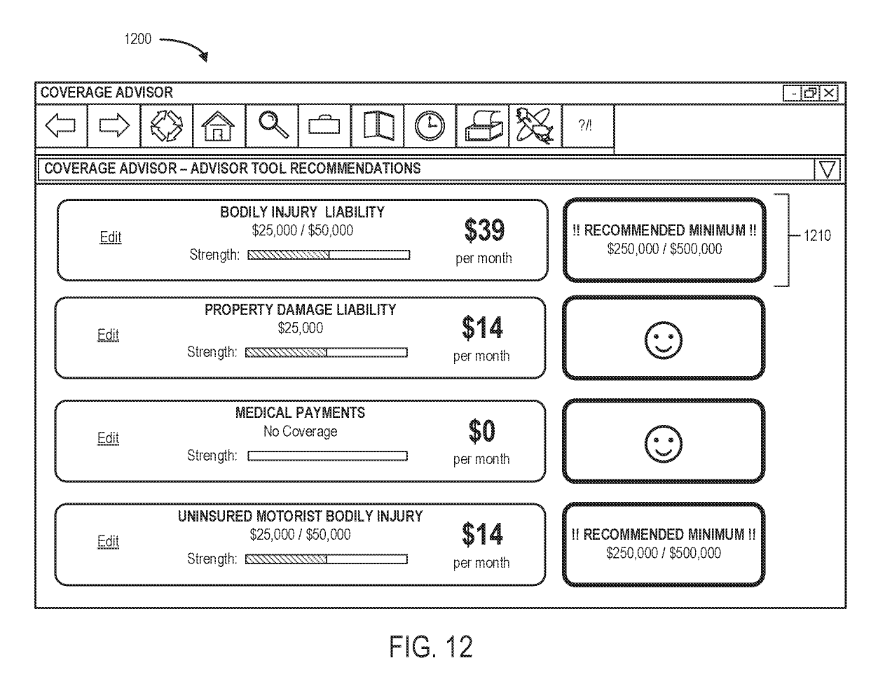

After the insurance coverage advisor tool information is submitted to the back-end insurance application computer server (e.g., financial information and/or other types of data), the back-end insurance application insurance server may exchange information with a cloud-based advanced data analytics platform to determine one or more recommended adjustments to the requested insurance policy coverages. FIG. 12 illustrates an advisor tool recommendation display 1200 that might be provided to a potential insured according to some embodiments. In particular, the recommendation display 1200 includes one or more recommended adjustments 1210 to the currently selected insurance policy coverages. For example, the recommended adjustment 1210 might indicate that the potential insured should increase a coverage limit, decrease a coverage limit, etc. The recommendations might be based on, for example, the potential client's financial information, demographic information, location information, etc.

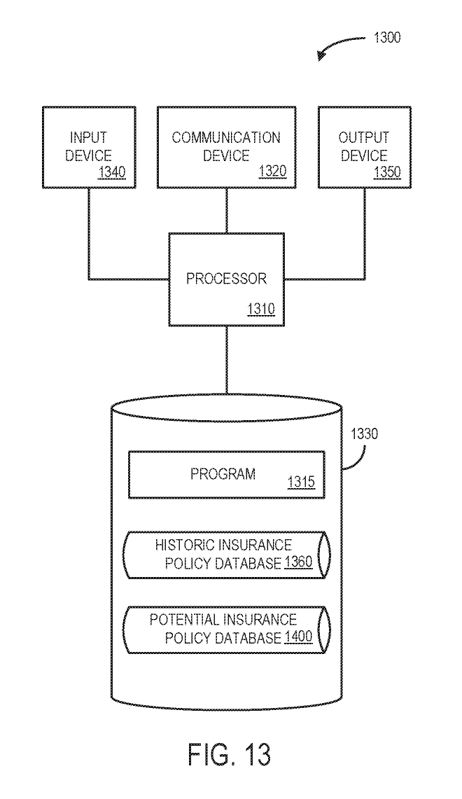

The embodiments described herein may be implemented using any number of different hardware configurations. For example, FIG. 13 illustrates an insurance coverage advisor platform 1300 that may be, for example, associated with the system 100 of FIG. 1. The insurance coverage advisor platform 1300 comprises a processor 1310, such as one or more commercially available Central Processing Units (“CPUs”) in the form of one-chip microprocessors, coupled to a communication device 1320 configured to communicate via a communication network (not shown in FIG. 13). The communication device 1320 may be used to communicate, for example, with one or more remote potential insured devices. Note that communications exchanged via the communication device 1320 may utilize security features, such as those between a public internet user and an internal network of the insurance enterprise. The security features might be associated with, for example, web servers, firewalls, and/or PCI infrastructure. The insurance coverage advisor platform 1300 further includes an input device 1340 (e.g., a mouse and/or keyboard to enter information about insurance configurations, historic information, predictive models, etc.) and an output device 1350 (e.g., to output reports regarding system administration, recommendations, and/or insurance policies).

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1315 and/or a coverage advisor tool or application for controlling the processor 1310. The processor 1310 performs instructions of the program 1315, and thereby operates in accordance with any of the embodiments described herein. For example, the processor 1310 may receive from a remote computer a first set of parameters. The processor 1310 may automatically identify an initial set of values based on the first set of parameters and historic interaction information and render an initial display on the remote computer including information about the initial set of values. The processor 1310 may then receive a recommendation request including a second set of parameters and automatically exchange information with a cloud-based advanced data analytics platform to determine at least one recommended adjustment. The processor 1310 may then render a recommendation display on the remote computer including the initial set of values and the at least one recommended adjustment.

The program 1315 may be stored in a compressed, uncompiled and/or encrypted format. The program 1315 may furthermore include other program elements, such as an operating system, a database management system, and/or device drivers used by the processor 1310 to interface with peripheral devices.

As used herein, information may be “received” by or “transmitted” to, for example: (i) the insurance coverage advisor platform 1300 from another device; or (ii) a software application or module within the insurance coverage advisor platform 1300 from another software application, module, or any other source.

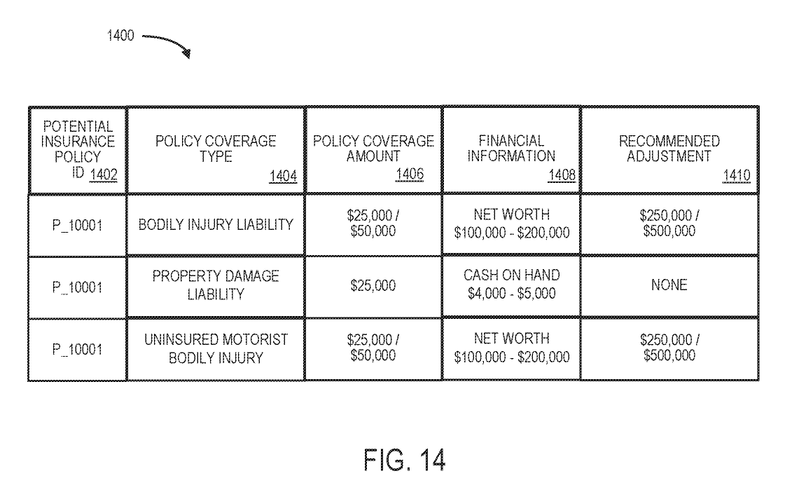

In some embodiments (such as shown in FIG. 13), the storage device 1330 further stores a historic insurance policy database 1360 (e.g., associated with past policies, premiums, claims, damages, etc.) and a potential insurance policy database 1400. An example of a database that might be used in connection with the insurance coverage advisor platform 1300 will now be described in detail with respect to FIG. 14. Note that the database described herein is only an example, and additional and/or different information may be stored therein. Moreover, various databases might be split or combined in accordance with any of the embodiments described herein. For example, the historic insurance policy 1360 and/or potential insurance policy database 1400 might be combined and/or linked to each other within the program 1315.

Referring to FIG. 14, a table is shown that represents the potential insurance policy database 1400 that may be stored at the insurance coverage advisor platform 1300 according to some embodiments. The table may include, for example, entries identifying insurance coverages of potential insurance policies. The table may also define fields 1402, 1404, 1406, 1408, 1410 for each of the entries. The fields 1402, 1404, 1406, 1408, 1410 may, according to some embodiments, specify: a potential insurance policy identifier 1402, policy coverage type 1404, policy coverage limit 1406, financial information 1408, and a recommended adjustment 1410. The potential insurance policy database 1400 may be created and updated, for example, based on information electrically received from a potential insured computer and/or a cloud-based advanced data analytics platform.

The potential insurance policy identifier 1402 may be, for example, a unique alphanumeric code identifying an insurance policy being quoted and/or underwritten for a potential customer. The policy coverage type 1404 and policy coverage amount 1406 might define certain characteristics of the potential insurance policy. For example, as illustrated by the first entry in FIG. 14, the potential insurance policy has bodily injury liability limits of $25,000 and $50,000. The potential insurance policy database 1400 may further store supplemental information that may be used to make recommended adjustments, such as financial information 1408. Based on the information in the potential insurance policy database 1400, a cloud-based advanced data analytics platform may generate one or more recommended adjustments 1410 to be presented to the potential insured (e.g., “people having a similar net worth as you generally opt to purchase an insurance coverage with s higher limit”).

Thus, embodiments may provide an automated and efficient way to provide recommendations. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

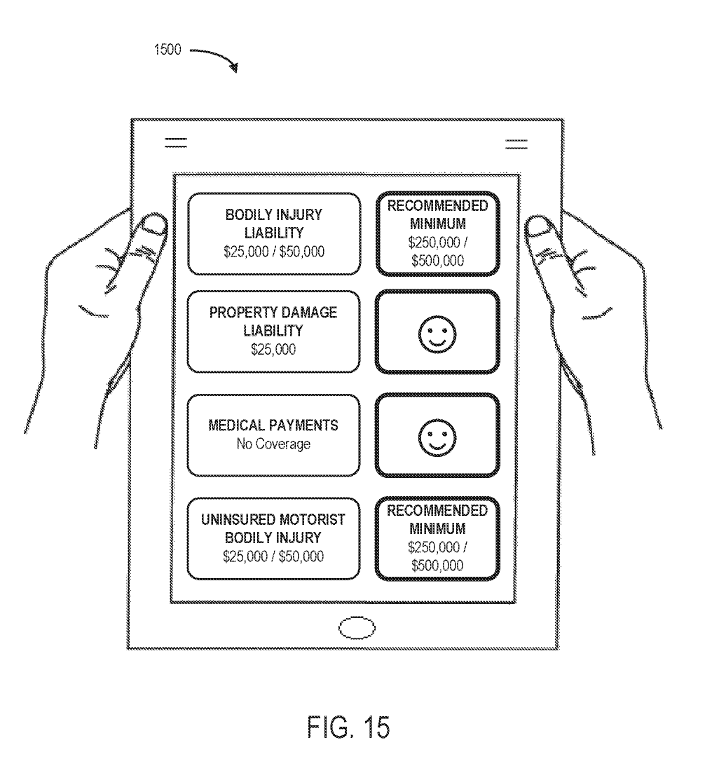

Although specific hardware and data configurations have been described herein, note that any number of other configurations may be provided in accordance with embodiments of the present invention (e.g., some of the information associated with insurance coverage recommendations might be implemented as a virtual or augmented reality display and/or the databases described herein may be combined or stored in external systems). Moreover, although embodiments have been described with respect to personal insurance, embodiments may instead be associated with a business. In addition, some or all of the information described herein might be shared (e.g., manually or automatically) via a social media platform, such as by posting recommendation results to a social media account. Still further, the displays and devices illustrated herein are only provided as examples, and embodiments may be associated with any other types of user interfaces. For example, FIG. 15 illustrates a handheld insurance coverage advisor tool recommendation display 1500 according to some embodiments.

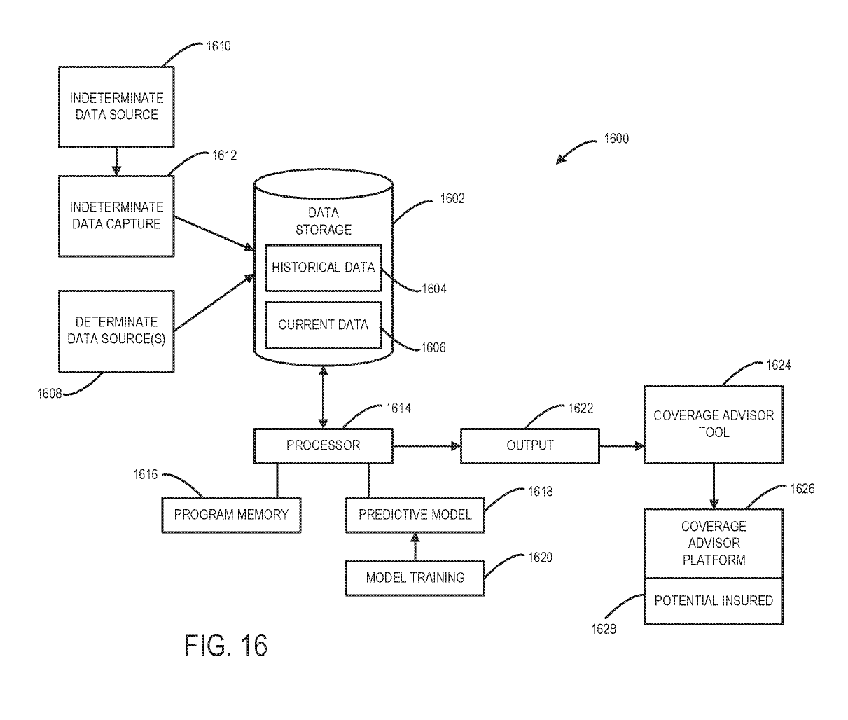

According to some embodiments, one or more predictive models may be used to provide an initial premium value and/or to provide recommendations to a potential insured. Features of some embodiments associated with a predictive model will now be described by first referring to FIG. 16. FIG. 16 is a partially functional block diagram that illustrates aspects of a computer system 1600 provided in accordance with some embodiments of the invention. For present purposes it will be assumed that the computer system 1600 is operated by an insurance company (not separately shown) for the purpose of supporting automated insurance advisor recommendations.

The computer system 1600 includes a data storage module 1602. In terms of its hardware the data storage module 1602 may be conventional, and may be composed, for example, by one or more magnetic hard disk drives. A function performed by the data storage module 1602 in the computer system 1600 is to receive, store and provide access to both historical transaction data (reference numeral 1604) and current transaction data (reference numeral 1606). As described in more detail below, the historical transaction data 1604 is employed to train a predictive model to provide an output that indicates a recommendation acceptance rate, and the current transaction data 1606 is thereafter analyzed by the predictive model. Moreover, as time goes by, and results become known from processing current transactions, at least some of the current transactions may be used to perform further training of the predictive model. Consequently, the predictive model may thereby adapt itself to changing recommendation results.

Either the historical transaction data 1604 or the current transaction data 1606 might include, according to some embodiments, determinate and indeterminate data. As used herein and in the appended claims, “determinate data” refers to verifiable facts such as: an age of a home; an automobile type; a policy date or other date; a driver age; a time of day; a day of the week; a geographic location, address or ZIP code; and/or a policy number.

As used herein, “indeterminate data” refers to data or other information that is not in a predetermined format and/or location in a data record or data form. Examples of indeterminate data include narrative speech or text, information in descriptive notes fields and signal characteristics in audible voice data files.

The determinate data may come from one or more determinate data sources 1608 that are included in the computer system 1600 and are coupled to the data storage module 1602. The determinate data may include “hard” data like a claimant's name, date of birth, social security number, policy number, address, etc. One possible source of the determinate data may be the insurance company's policy database (not separately indicated).

The indeterminate data may originate from one or more indeterminate data sources 1610, and may be extracted from raw files or the like by one or more indeterminate data capture modules 1612. Both the indeterminate data source(s) 1610 and the indeterminate data capture module(s) 1612 may be included in the computer system 1600 and coupled directly or indirectly to the data storage module 1602. Examples of the indeterminate data source(s) 1610 may include data storage facilities for document images, for text files, and digitized recorded voice files. Examples of the indeterminate data capture module(s) 1612 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual.

The computer system 1600 also may include a computer processor 1614. The computer processor 1614 may include one or more conventional microprocessors and may operate to execute programmed instructions to provide functionality as described herein. Among other functions, the computer processor 1614 may store and retrieve historical insurance transaction data 1604 and current transaction data 1606 in and from the data storage module 1602. Thus the computer processor 1614 may be coupled to the data storage module 1602.

The computer system 1600 may further include a program memory 1616 that is coupled to the computer processor 1614. The program memory 1616 may include one or more fixed storage devices, such as one or more hard disk drives, and one or more volatile storage devices, such as RAM devices. The program memory 1616 may be at least partially integrated with the data storage module 1602. The program memory 1616 may store one or more application programs, an operating system, device drivers, etc., all of which may contain program instruction steps for execution by the computer processor 1614.

The computer system 1600 further includes a predictive model component 1618. In certain practical embodiments of the computer system 1600, the predictive model component 1618 may effectively be implemented via the computer processor 1614, one or more application programs stored in the program memory 1616, and computer stored as a result of training operations based on the historical transaction data 1604 (and possibly also data received from a third party). In some embodiments, data arising from model training may be stored in the data storage module 1602, or in a separate computer store (not separately shown). A function of the predictive model component 1618 may be to determine appropriate recommended adjustments to insurance coverages. The predictive model component may be directly or indirectly coupled to the data storage module 1602.

The predictive model component 1618 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1600 includes a model training component 1620. The model training component 1620 may be coupled to the computer processor 1614 (directly or indirectly) and may have the function of training the predictive model component 1618 based on the historical transaction data 1604 and/or information about potential insureds. (As will be understood from previous discussion, the model training component 1620 may further train the predictive model component 1618 as further relevant data becomes available.) The model training component 1620 may be embodied at least in part by the computer processor 1614 and one or more application programs stored in the program memory 1616. Thus the training of the predictive model component 1618 by the model training component 1620 may occur in accordance with program instructions stored in the program memory 1616 and executed by the computer processor 1614.

In addition, the computer system 1600 may include an output device 1622. The output device 1622 may be coupled to the computer processor 1614. A function of the output device 1622 may be to provide an output that is indicative of (as determined by the trained predictive model component 1618) particular simulation results, scores, and upsell recommendations. The output may be generated by the computer processor 1614 in accordance with program instructions stored in the program memory 1616 and executed by the computer processor 1614. More specifically, the output may be generated by the computer processor 1614 in response to applying the data for the current simulation to the trained predictive model component 1618. The output may, for example, be a monetary estimate and/or likelihood within a predetermined range of numbers. In some embodiments, the output device may be implemented by a suitable program or program module executed by the computer processor 1614 in response to operation of the predictive model component 1618.

Still further, the computer system 1600 may include a coverage advisor tool module 1624. The coverage advisor tool module 1624 may be implemented in some embodiments by a software module executed by the computer processor 1614. The coverage advisor tool module 1624 may have the function of rendering a portion of the display on the output device 1622. Thus the coverage advisor tool module 1624 may be coupled, at least functionally, to the output device 1622. In some embodiments, for example, the coverage advisor module 1624 may direct workflow by referring, to a potential insured 1628 via a coverage advisor platform 1228, current recommendation results generated by the predictive model component 1618 and found to be associated with various results or scores. In some embodiments, these recommendations may be provided to an insurance agent and/or a potential insured 1628 who may also be offered insurance upgrades as appropriate.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to improve data exchange over a distributed communication network via an automated back-end application computer server, comprising:
(a) a computer store containing data for a plurality of prior interactions, including historic interaction information for each interaction;
(b) a cloud-based advanced data analytics platform interface to exchange information with a cloud-based advanced data analytics platform;
(c) a communication port to facilitate an exchange of electronic messages with a remote client computer via the distributed communication network, the remote client computer being associated with a potential client entity; and
(d) the back-end application computer server, coupled to the computer store, the cloud-based advanced data analytics platform interface, and the communication port, and programmed to:
(i) receive from the remote client computer a first set of parameters,
(ii) automatically identify an initial set of values based on the first set of parameters and the historic interaction information, including historic interaction information associated with entities other than the potential client entity,
(iii) render an initial display on the remote client computer including information about the initial set of values,
(iv) receive from the remote client computer a recommendation request including a second set of parameters, the second set of parameters being different than the first set of parameters,
(v) automatically exchange information with the cloud-based advanced data analytics platform, including information about the second set of parameters, to determine at least one recommended adjustment associated with the initial set of values, and
(vi) render a recommendation display on the remote client computer including the initial set of values and the at least one recommended adjustment.

2. The system of claim 1, wherein the cloud-based advanced data analytics platform includes at least one of: an instance created for the back-end application computer server, security features, a cognitive computing service, and content services.

3. The system of claim 1, wherein at least one of the second set of parameters and the recommended adjustment are exchanged with the remote client computer via a real-time interactive chat application.

4. The system of claim 1, wherein the first set of parameters includes at least one of: vehicle information for at least one vehicle, driver information for at least one driver, address information, discount information for at least one discount, and driving incident information.

5. The system of claim 4, wherein the initial set of values includes at least one of: a bodily injury liability value, a property damage liability value, a medical payment value, an uninsured and underinsured motorist bodily injury value, an uninsured motorist property damage value, a towing and labor roadside assistance value, a rental reimbursement value, a comprehensive coverage value, and at least one insurance premium value.

6. The system of claim 5, wherein the second set of parameters includes at least one of: a net worth value, an amount of funds currently available value, an existing roadside assistance plan value, a health insurance deductible value, and a retirement savings value.

7. The system of claim 1, wherein the first set of parameters is associated with at least one of: a potential automobile insurance policy, and a potential homeowner's insurance policy.

8. A system to improve data exchange over the Internet via an automated back-end insurance application computer server, comprising:
(a) a historic insurance computer store containing data for a plurality of prior insurance policies, including historic claim information for each insurance policy;
(b) a cloud-based advanced data analytics platform interface to exchange information with a cloud-based advanced data analytics platform;
(c) a communication port to facilitate an exchange of electronic messages with a remote potential insured computer via the Internet, the remote potential insured computer being associated with a potential insured entity; and
(d) the back-end insurance application computer server, coupled to the historic insurance computer store, the cloud-based advanced data analytics platform interface, and the communication port, and programmed to:
(i) receive from the remote potential insured computer a set of underwriting parameters,
(ii) automatically identify an initial set of insurance coverage values and associated premiums based on the set of underwriting parameters and the historic claim information, including historic claim information associated with entities other than the potential insured entity,
(iii) render an initial display on the remote potential insured computer including the initial set of insurance coverage values and associated premiums,
(iv) receive from the remote potential insured computer a recommendation request including a set of financial parameters,
(v) automatically exchange information with the cloud-based advanced data analytics platform, including information about the set of financial parameters, to determine at least one recommended insurance adjustment associated with the initial set of insurance coverage values and associated premiums, and
(vi) render a recommendation display on the remote potential insured computer including the initial set of insurance coverage values and associated premiums along with the at least one recommended insurance adjustment.

9. The system of claim 8, wherein the cloud-based advanced data analytics platform includes at least one of: an instance created for the back-end application computer server, security features, a cognitive computing service, and content services.

10. The system of claim 8, wherein at least one of the set of financial parameters and the recommended insurance adjustment are exchanged with the remote potential insured computer via a real-time interactive chat application.

11. The system of claim 8, wherein the set of underwriting parameters includes at least one of: vehicle information for at least one vehicle, driver information for at least one driver, address information, discount information for at least one discount, and driving incident information.

12. The system of claim 11, wherein the initial set of insurance coverage values and associated premiums includes at least one of: a bodily injury liability value, a property damage liability value, a medical payment value, an uninsured and underinsured motorist bodily injury value, an uninsured motorist property damage value, a towing and labor roadside assistance value, a rental reimbursement value, and a comprehensive coverage value.

13. The system of claim 12, wherein the set of financial parameters includes at least one of: a net worth value, an amount of funds currently available value, an existing roadside assistance plan value, a health insurance deductible value, and a retirement savings value.

14. The system of claim 8, wherein the set of underwriting parameters are associated with at least one of: a potential automobile insurance policy, and a potential homeowner's insurance policy.

15. A computerized method to improve data exchange over the Internet via an automated back-end insurance application computer server, comprising:
exchanging electronic messages with a remote potential insured computer via the Internet, the remote potential insured computer being associated with a potential insured entity;
receiving, by a back-end insurance application computer server from the remote potential insured computer, a set of underwriting parameters;
automatically identifying, by the back-end insurance application computer server, an initial set of insurance coverage values and associated premiums based on the set of underwriting parameters and the historic claim information, including historic claim information associated with entities other than the potential insured entity;
rendering, by the back-end insurance application computer server, an initial display on the remote potential insured computer including the initial set of insurance coverage values and associated premiums;
receiving, by the back-end insurance application computer server from the remote potential insured computer, a recommendation request including a set of financial parameters;
automatically exchange information with the cloud-based advanced data analytics platform, including information about the set of financial parameters, to determine at least one recommended insurance adjustment associated with the initial set of insurance coverage values and associated premiums; and
rendering a recommendation display on the remote potential insured computer including the initial set of insurance coverage values and associated premiums along with the at least one recommended insurance adjustment.

16. The method of claim 15, wherein the cloud-based advanced data analytics platform includes at least one of: an instance created for the back-end application computer server, security features, a cognitive computing service, and content services.

17. The method of claim 15, wherein at least one of the set of financial parameters and the recommended insurance adjustment are exchanged with the remote potential insured computer via a real-time interactive chat application.

18. The method of claim 15, wherein the set of underwriting parameters includes at least one of: vehicle information for at least one vehicle, driver information for at least one driver, address information, discount information for at least one discount, and driving incident information.

19. The method of claim 18, wherein the initial set of insurance coverage values and associated premiums includes at least one of: a bodily injury liability value, a property damage liability value, a medical payment value, an uninsured and underinsured motorist bodily injury value, an uninsured motorist property damage value, a towing and labor roadside assistance value, a rental reimbursement value, and a comprehensive coverage value.

20. The method of claim 19, wherein the set of financial parameters includes at least one of: a net worth value, an amount of funds currently available value, an existing roadside assistance plan value, a health insurance deductible value, and a retirement savings value.

21. The method of claim 8, wherein the set of underwriting parameters are associated with at least one of: a potential automobile insurance policy, and a potential homeowner's insurance policy.

22. An advanced data analytics system, comprising:
a) a data store including a first set of parameters received from a remote client computer associated with a potential client entity, the first set of parameters being associated with an initial set of values; and
b) a computer processor coupled to the data store and in communication through the Internet with a cloud-based advanced data analytics platform and programmed, upon receiving from the remote client computer a recommendation request including a second set of parameters, different than the first set of parameters, to automatically exchange information with the cloud-based advanced data analytics platform to determine at least one recommended adjustment and to serve a web page to the remote client computer with the at least one recommended adjustment graphically displayed proximate to an associated initial value.

23. The advanced data analytics system of claim 22, wherein the potential client entity is associated with at least one of: (i) a new client entity, and (ii) an existing client entity.
